(19) United States
(12) Patent Application Publication
(10) Pub. No.: US 2006/0193200 A1
(43) Pub. Date: Aug. 31, 2006

(54) Measurement indicator for a blender cup or the like

(76) Inventor: John Michael Herbert, Winchester, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/333,884

(22) Filed: Jan. 18, 2006

Related U.S. Application Data
(60) Provisional application No. 60/656,288, filed on Feb. 25, 2005.

(51) Int. Cl. A47J 43/046

(52) U.S. Cl. 366/314

(57) ABSTRACT

A device for providing a visual indication of the amount of liquid or other materials in a blender cup or other receptacle is provided. The device is mounted on the rotatable impeller shaft in the base of the cup, and preferably is employed to affix the impeller to the shaft. Graduations formed as part of or provided on the device at appropriate locations provide a visual indication of the amount of ingredients introduced.

### RELATED APPLICATIONS

This application claims priority to, and incorporates by reference, the entire disclosure of U.S. Provisional Patent Application No. 60/656,288, filed on Feb. 25, 2005.

### TECHNICAL FIELD

This invention relates to a measurement indicator for a blender cup or other receptacle having an impeller mounted on a rotating shaft in the base of the cup or receptacle, and more particularly to a graduated indicator affixed to the shaft, so that the volume amount of liquid or other material introduced into the cup may be readily visually determined.

### BACKGROUND

This invention may be more readily understood by reference to U.S. Pat. No. 4,681,030 entitled “Apparatus for Making Frozen Drinks,” and U.S. Pat. No. 6,095,677 entitled “Magnetic Drive Blender,” both owned by Island Oasis Frozen Cocktail Company, Inc., of Walpole, Mass. The disclosures of those two patents are incorporated herein by reference. Each of those patents describes an apparatus for preparing frozen drinks utilizing an ice dispensing machine and a blender having a blender cup for receipt of the drink ingredients and the dispensed ice.

In making a frozen drink with the apparatus shown and described in those patents, the base ingredients—fruit, liquor, etc.—are first added to the blender cup, and then, in a timed sequence, finely divided ice is introduced from the spout or discharge port of the ice-dispensing machine as the blender operates. Impeller blades mounted on a rotatable shaft in the base of the blender cup blend the ice with the other ingredients to make a frozen drink. One of the primary advantages of the Island Oasis brand machines is the saving of the bartender's time and energy by reducing the number of physical movements and the amount of time required to make a frozen drink.

The present invention even further reduces the number of physical movements and the amount of time required in making a frozen drink. Typically, a bartender would measure out a desired amount of the base ingredients in a ladle or a measuring cup and then add that amount to the blender cup. This would entail (1) locating and picking up the ladle or measuring cup, (2) filling it as desired with the ingredient(s) to be added, which ingredients are usually kept in a “pour bottle” (i.e., typically a plastic bottle having at long snout), (3) emptying the contents of the ladle or measuring cup into the blender cup, (4) cleaning the ladle or measuring cup, and then (5) placing it in a convenient location for use in making the next drink. If more than one ingredient is to be added, it may be necessary to repeat the first four steps for each ingredient. The present invention eliminates all those steps by providing within the blender cup a visual means for readily determining the volume amount of the ingredients that have been introduced directly into the cup.

It is an object of this invention to provide an indicator that will give a ready and accurate visual indication of the volume amount of ingredients contained in the blender cup or other receptacle.

It is a further object of this invention to provide a device that will be of particular use in connection with the making of frozen drinks by a bartender.

It is still another object of this invention to provide a device that will be easy to install and to clean, and will save the user's time and physical energy by reducing the number of motions and the time spent in making a frozen drink or other concoction.

### SUMMARY OF THE INVENTION

The foregoing objects are achieved and the foregoing problems solved by one illustrative embodiment of the invention in which an improved blender cup or receptacle has a measurement indicator mounted on the impeller shaft at the base of the cup or receptacle, the device being graduated to provide a visual indication of the volume amount of liquid or other material that has been introduced into the cup.

In one embodiment, a receptacle for receiving ingredients has a shaft in the base of the receptacle and a measurement indicator is affixed to the shaft, The measurement indicator is so graduated as to provide a visual indication of the volume amount of ingredients contained in the receptacle.

In some aspects, the shaft is rotatable and an impeller is secured to the rotatable shaft by the measurement indicator. The measurement indicator is shaped to accommodate a tool for affixing the measurement indicator to the shaft and one or more sections of the measurement indicator have hexagonal cross-sections to accommodate the tool.

In some aspects, the measurement indicator is graduated by having at least two sections of differing cross-sections along the length of the measurement indicator, with intersections between the sections providing the visual indication of the volume amounts of ingredients. In some aspects, one or more intersections form annular surfaces and/or include toroids, with outer diameters greater than the corresponding dimensions of the sections adjoining the intersections.

In one embodiment, a measurement indicator for a receptacle that has an impeller secured to a rotatable shaft mounted in the base of the receptacle, includes a fastener affixable to the shaft and shaped with graduations for indicating the volume of ingredients in the receptacle.

In some aspects, the impeller is secured to the rotatable shaft by the indicator. In some aspects, one or more of the graduations are shaped to accommodate a tool for affixing the fastener to the shaft to secure the impeller, with the graduations having a hexagonal cross-section.

In some aspects, the graduations include at least two sections of differing cross-sections along the length of the measurement indicator, with the intersections between the sections indicating the volume of ingredients in the receptacle. In some aspects, one or more of the intersections form annular surfaces, protrusions, and/or toroids, the toroids having outer diameters greater than corresponding dimensions of the sections adjoining the at least one intersection.

In some aspects, at least one of the sections has a hexagonal cross-section to accommodate a tool for affixing the measurement indicator to the shaft and, in some aspects, other sections have cylindrical shapes. In some aspects, the sections have progressively smaller cross-sections the further the sections are from the base of the receptacle.

In one embodiment, a measurement indicator for a receptacle that has an impeller secured to a rotatable shaft mounted in the base of the receptacle, includes a fastener affixable to the shaft and bearing graduations for indicating the volume of ingredients in the receptacle. In some aspects, the impeller is secured to the rotatable shaft by the indicator.

### BRIEF DESCRIPTION OF THE DRAWINGS

The following figures depict certain illustrative embodiments in which like reference numerals refer to like elements. These depicted embodiments are to be understood as illustrative and not as limiting in any way.

FIG. 1 is a perspective view of a prior art frozen drink apparatus with which the measurement indicator of the present invention may be employed.

FIG. 2 is an exploded perspective view of the blender cup of FIG. 1, depicting the various part of the impeller assembly.

FIG. 3 is an exploded perspective view of the blender blade and shaft assembly in accordance with one embodiment of the instant invention, wherein a graduated fastener is attached to the rotatable shaft of the impeller assembly, to provide a visual indication of the volume amount of liquid or other material that has been introduced into the blender cup.

FIGS. 4a, b, and c depict several alternative constructions for the graduated fastener.

FIG. 5 is a perspective view of the blender cup in which the graduated fastener of FIG. 4a is visible through the transparent sidewalls of the cup.

FIG. 6 is a view into the blender cup from above, showing the device of FIG. 4a affixed to the impeller shaft.

### DETAILED DESCRIPTION OF SPECIFIC EMBODIMENTS

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the disclosed systems or methods.

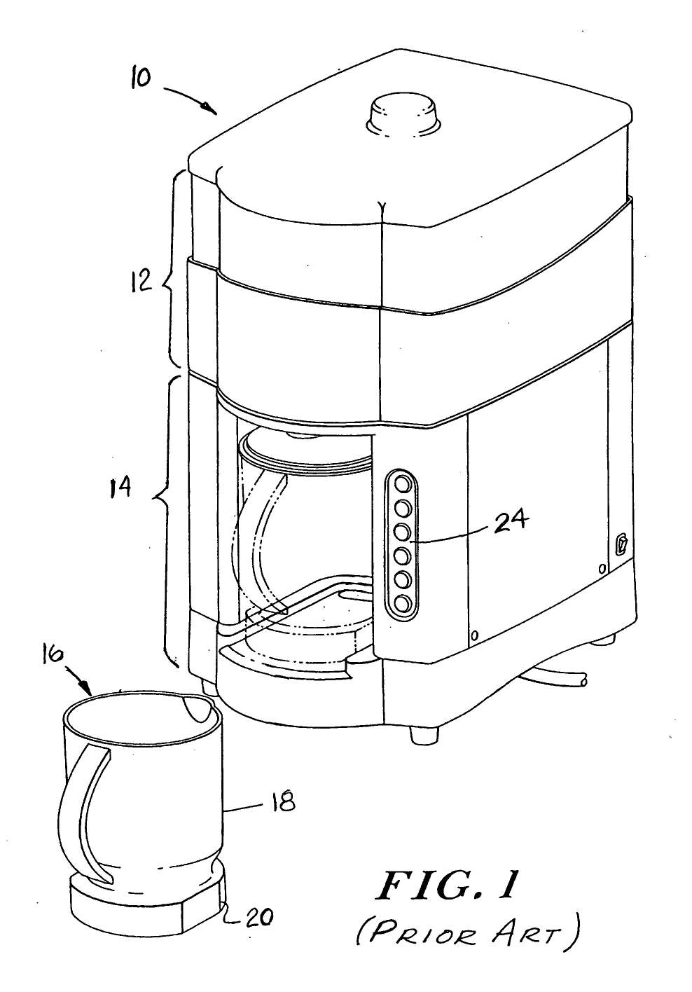

For illustrative purposes, the present invention is described in combination with a frozen drink apparatus as described in one or more U.S. patents previously referenced herein. However, it will be understood that the present invention is not limited to the described combination and can be used with other types of apparatus to provide a visual indication of the volume amount of liquid or other material that has been introduced into a receptacle. FIG. 1 depicts, in perspective view, the frozen drink apparatus described in U.S. Pat. No. 6,095,677. That apparatus 10 comprises an ice shaver portion, shown generally at 12, mounted above a blender area shown generally at 14. Blender cup 16 is typically constructed with a transparent plastic body 18 and a plastic base 20 to which the blender cup body 18 may be removably attached.

In making a frozen drink, the operator of the machine first introduces the base ingredients of the drink into the blender cup 16—for example, a strawberry daiquiri concentrate. The blender cup is then placed in position in the machine, as shown in dashed lines. The ice shaver delivers a pre-selected amount of shaved ice into the blender cup via a spout (not shown in FIG. 1). Control buttons 24 permit the operator of the machine to choose the number of frozen drinks to be made. That choice of the number of drinks determines the amount of time the shaver will operate in delivering ice to the blender cup, as well as how long the blender will operate in blending the ingredients and the ice.

The amount of base ingredient(s) initially introduced by the operator must, of course, be correlated with the number of drinks that the operator has chosen to prepare. If, for example, the operator plans to make two frozen drinks, a certain predetermined amount of base ingredient(s) is introduced into the blender cup before the cup is placed in position in the machine. As discussed above, the operator typically would measure out the amount of base ingredient by using a separate measuring cup or ladle.

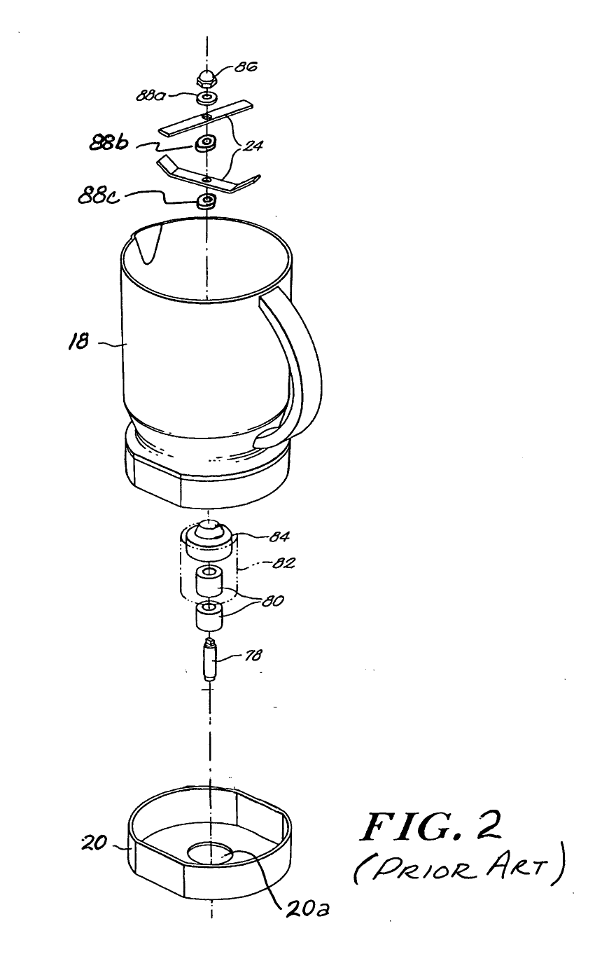

FIG. 2 depicts the construction of the blender impeller shaft mechanism for the Magnetic Drive Blender described in U.S. Pat. No. 6,095,677. Shaft 78 is journalled in a stacked pair of needle bearing assemblies 80. A surrounding brass collar 82 press fit into a central, cylindrical-walled opening 20a in the plastic base 20 holds the bearing assemblies 80. At the bottom of the cup body 18, collar 82 has an enlarged diameter counter bore that receives and secures a rotary seal 84 formed of a suitably elastomeric material such as a wear-resistant rubber. The seal 84 provides a low-friction running or sliding seal around the shaft 78, and serves to retain liquid in the cup 16 despite the presence of a rotating shaft penetrating the bottom wall of the cup body 18. Above the seal, an acorn nut 86 threaded on the upper end of the shaft 78 secures the blades 24 sandwiched between three washers 88a, 88b, and 88c. Further description of the drive assembly may be found at columns 6 and 7 of U.S. Pat. No. 6,095,677.

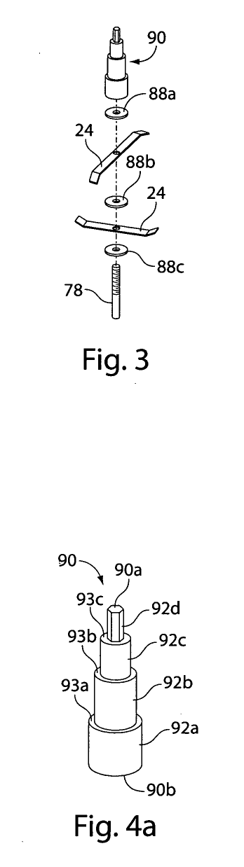

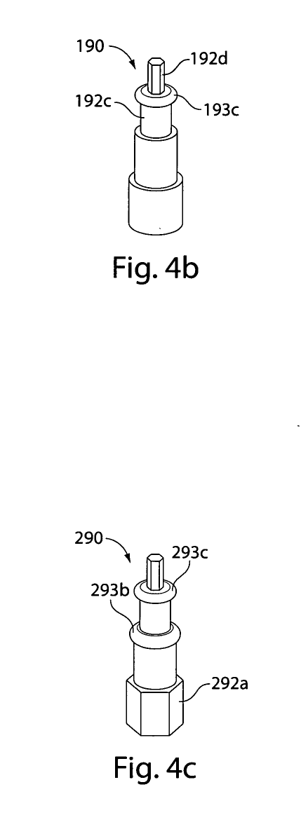

In accordance with the instant invention, as shown in FIG. 3, shaft 78 is externally threaded at its upper portion, and acorn nut 86 is replaced by a graduated and elongated fastener 90 having an internally threaded bore to mate with the threads of shaft 78. The fastener 90 is preferably formed of stainless steel, and may be shaped or marked with graduations along its length to provide visual markers corresponding to the volume of ingredients that have been introduced into the blender cup. For example, three of many possible shapes for the fastener are depicted in FIGS. 4a, 4b, and 4c. Alternatively, shaft 78 can extend past a blade fastener nut and fastener 90 can be threaded onto extended shaft 78 above the blade fastener nut (not shown).

The fastener in FIG. 4a is formed with three cylindrical sections of different diameter (92a, 92b, and 92c), and a fourth section (92d) at the top having a hexagonal cross-section to enable gripping with a tool. The section with the largest diameter is located at the lower end, and the sections above decrease in diameter. At the point of intersection of sections 92a and 92b, an annular surface 93a is visible; likewise, similar surfaces 93b and 93c are visible at the intersections of sections 92b and 92c, and sections 92c and 92d, respectively. These sections are vertically dimensioned so that the graduations at 93a, 93b, and 93c correspond to the volume of ingredients required to make one, tow, and three frozen drinks, respectively. The top surface 90a of fastener 90 indicates the four drink level. The vertical distance between graduations depends, of course, on the shape of the cup or receptacle. For example, the cup of FIG. 1 is narrower at its base than its main body; consequently, in order for the graduations on the fastener 90 to signify equal volumes, the distance from the bottom 90b of fastener 90 to the first graduation at 93a is greater than the distance, say from the third graduation 93c to the top surface 90a of the fastener 90.

When a bartender desires to make one frozen drink, he or she introduces ingredients until the volume amount in the blender cup is seen to reach the first graduation at annular surface 93a. The other graduations signify two and three drinks, and the top four drinks. Preferably, each graduation corresponds to an additional 4 ounces of ingredients. In a typical frozen drink, the ratio of base ingredients to total drink volume is 1 to 3, so that for a 12 ounce drink, 4 ounces of base ingredients are introduced into the blender cup before the machine operation is commenced.

The fasteners of FIGS. 4b and 4c are shaped differently than that of FIG. 4a, but are shaped for the same purpose, with three graduations. FIG. 4b illustrates a fastener 190 having toroid 193c at the intersection of sections 192c and 192d. The diameter of toroid 193c is greater than that of section 192c, such that toroid 193c can be seen more easily when the level of the ingredients in the cup reach just above the intersection of sections 192c and 192d than would corresponding annular surface 93c of FIG. 4a be seen if the level of ingredients were just above the intersection of sections 92c and 92d. FIG. 4c illustrates a fastener 290 having toroids 293b and 293c similar to toroid 193c of FIG. 4b. Shapes other than toroids can be used at the intersections to provide a clear demarcation between the sections, e.g., disc-shapes, knobs, or other protrusions. In addition, section 292a has a hexagonal cross section that can accommodate greater torque when being attached to shaft 78 than can hexagonal section 92d.

Alternatively, instead of forming the graduation indicators as part of the fastener, they may be etched, affixed, or otherwise applied at appropriate locations on the fastener, e.g., the graduation indicators can include markings in different colors. Other alternative combinations of annular surfaces, toroids, protrusions or other demarcations between the sections can be contemplated, as well as other cross-sectional shapes. Additionally, the graduations can correspond to other than the number of drinks being made. For example, some drinks include multiple ingredients. The graduations can correspond to cumulative volumes for each ingredient being added.

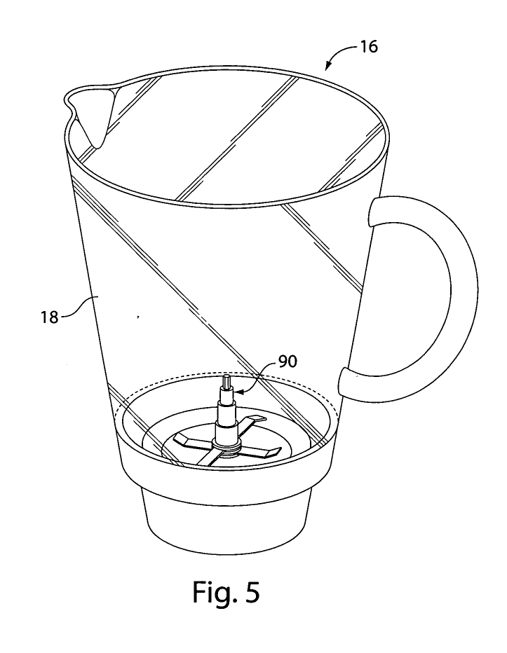

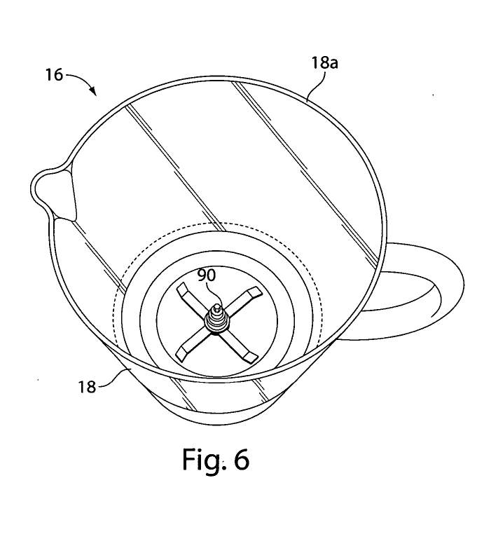

FIGS. 5 and 6 are simple illustrations of the measurement indicator of the instant invention when fastened onto the blender cup shaft. FIG. 5 is a perspective view of the blender cup 16 in which the fastener 90 of FIGS. 3 and 4a is visible through the transparent sidewalls of the cup body 18. FIG. 6 is a perspective view of the blender cup 16 from above the rim 18a of the cup body 18, with fastener 90 being directly visible. FIGS. 5 and 6 illustrate how an operator pouring liquid ingredients into the blender cup 16 is able to look through or down into the cup body 18 to judge the amount of ingredients that have been introduced by observing the level of ingredients rising against the graduated fastener 90.

It will be readily appreciated by those skilled in the art that the present invention in its broader aspects is not limited to the specific embodiments herein shown and described. Accordingly, variations may be made from the embodiments described herein which are within the scope of the accompanying claims, without departing from the principles of the invention and without sacrificing its chief advantages.

What is claimed is:

1. In a receptacle for receiving ingredients, the receptacle having a shaft in the base of the receptacle, the improvement comprising a measurement indicator affixed to said shaft and so graduated as to provide a visual indication of the volume amount of ingredients contained in the receptacle.

2. The receptacle of claim 1, wherein the shaft is rotatable and an impeller is secured to the rotatable shaft by the measurement indicator.

3. The receptacle of claim 2, wherein the measurement indicator is shaped to accommodate a tool for affixing the measurement indicator to the shaft.

4. The receptacle of claim 3, wherein at least one section of the measurement indicator has a hexagonal cross-section to accommodate the tool.

5. The receptacle of claim 1, wherein the measurement indicator is graduated by having at least two sections of differing cross-sections along a length of the measurement indicator and wherein intersections between the sections provide the visual indication of the volume amounts of ingredients.

6. The receptacle of claim 5, wherein the intersections form annular surfaces.

7. The receptacle of claim 5, wherein at least one of the intersections includes a toroid.

8. The receptacle of claim 7, wherein an outer diameter of the toroid is greater than corresponding dimensions of the sections adjoining the at least one intersection.

9. The receptacle of claim 5, wherein at least one of the intersections includes protrusions extending radially greater than the sections adjoining the at least one intersection.

10. The receptacle of claim 5, wherein at least one of the sections has a hexagonal cross-section to accommodate a tool for affixing the measurement indicator to the shaft.

11. A measurement indicator for a receptacle having an impeller secured to a rotatable shaft mounted in the base of said receptacle, comprising a fastener affixable to said shaft and shaped with graduations for indicating the volume of ingredients in the receptacle.

12. The of claim 11, in which the impeller is secured to the rotatable shaft by said indicator.

13. The measurement indicator of claim 12, wherein at least one of the graduations is shaped to accommodate a tool for affixing the fastener to the shaft to secure the impeller.

14. The measurement indicator of claim 13, wherein the at least one graduation has a hexagonal cross-section to accommodate the tool.

15. The measurement indicator of claim 11, wherein the graduations comprise at least two sections of differing cross-sections along a length of the measurement indicator and wherein intersections between the sections indicate the volume of ingredients in the receptacle.

16. The measurement indicator of claim 15, wherein the intersections form annular surfaces.

17. The measurement indicator of claim 15, wherein at least one of the intersections includes a toroid.

18. The measurement indicator of claim 17, wherein an outer diameter of the toroid is greater than corresponding dimensions of the sections adjoining the at least one intersection.

19. The measurement indicator of claim 15, wherein at least one of the intersections includes protrusions extending radially greater than the sections adjoining the at least one intersection

20. The measurement indicator of claim 15, wherein at least one of the sections has a hexagonal cross-section to accommodate a tool for affixing the measurement indicator to the shaft.

21. The measurement indicator of claim 15, comprising:
at least one of the sections having a hexagonal cross-section to accommodate a tool for affixing the measurement indicator to the shaft; and
others of the sections having a cylindrical shape, wherein the sections have progressively smaller cross-sections the further the sections are from the base of the receptacle.

22. A measurement indicator for a receptacle having an impeller secured to a rotatable shaft mounted in the base of said receptacle, comprising a fastener affixable to said shaft and bearing graduations for indicating the volume of ingredients in the receptacle.

23. The measurement indicator of claim 22, in which the impeller is secured to the rotatable shaft by said indicator.
